(19) United States
(12) Patent Application Publication
(10) Pub. No.: US 2016/0227454 A1
(43) Pub. Date: Aug. 4, 2016

(54) Method, Apparatus and Computer Program for Control of a Data Bearer

(71) Applicant: NOKIA SOLUTIONS AND NETWORKS OY, Espoo (FI)

(72) Inventors: Antti Anton TOSKALA, Espoo (FI); Harri Kalevi HOLMA, Helsinki (FI); Esa Markus METSALA, Espoo (FI)

(21) Appl. No.: 15/024,878

(22) PCT Filed: Sep. 27, 2013
(86) PCT No.: PCT/EP2013/070156

§ 371 Date: Mar. 25, 2016

(51) Int. Cl. H04W 36/04; H04W 76/02; H04W 76/04; H04W 36/00

(52) U.S. Cl. CPC H04W 36/04; H04W 36/0033; H04W 76/021; H04W 76/041

(57) ABSTRACT

A method including storing, at a first apparatus, information for identifying at least one data bearer, wherein the information includes an address and at least one further identifier for the data bearer; and wherein the data bearer is configured between s the aid first apparatus and one of a second apparatus and a third apparatus; and in response to receiving information, moving the at least one data bearer between the second apparatus and the third apparatus.

This disclosure relates to methods and apparatus and in particular but not exclusively to methods and apparatus for control of a data bearer.

A communication system can be seen as a facility that enables communication sessions between two or more nodes such as fixed or mobile devices, machine-type terminals, access nodes such as base stations, servers and so on. A communication system and compatible communicating entities typically operate in accordance with a given standard or specification which sets out what the various entities associated with the system are permitted to do and how that should be achieved. For example, the standards, specifications and related protocols can define the manner how devices shall communicate, how various aspects of communications shall be implemented and how devices for use in the system shall be configured.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a device such as a user equipment is used for enabling receiving and transmission of communications such as speech and content data.

Communications can be carried on wireless carriers. Examples of wireless systems include public land mobile networks (PLMN) such as cellular networks, satellite based communication systems and different wireless local networks, for example wireless local area networks (WLAN). In wireless systems a communication device provides a transceiver station that can communicate with another communication device such as e.g. a base station of an access network and/or another user equipment. The two directions of communications between a base station and communication devices of users have been conventionally referred to as downlink and uplink. Downlink (DL) can be understood as the direction from the base station to the communication device and uplink (UL) the direction from the communication device to the base station.

Some systems may have a number of small-cells overlying larger or macro-cells. The small-cells may share the same carrier with the macro-cell or use different carriers.

In a first aspect there is provided a method comprising: storing, at an apparatus, information for identifying at least one data bearer, wherein said information comprises an address and at least one further identifier for said data bearer; and wherein said data bearer is configured between said apparatus and one of a second apparatus and a third apparatus; and in response to receiving information, moving said at least one data bearer between said second apparatus and said third apparatus.

Preferably said address comprises a network address.

Preferably said further identifier comprises a general packet radio service tunnelling end-point identifier.

Preferably said method comprises storing said address and said at least one further identifier in a table.

Preferably said method comprises updating said table in response to said receiving information.

Preferably said method comprises matching at least one data packet to said at least one data bearer by examining a header of said at least one packet.

Preferably said examining a header comprises examining one or multiple header fields of said at least one packet.

Preferably said method comprises moving said bearer in response to a trigger comprising at least one of: user mobility; user data volume; user transmission frequency; user application; user priority; user quality of service class.

Preferably said first apparatus comprises a router.

Preferably said second apparatus controls one of a large cell and a small cell, and said third apparatus controls the other of said large cell and said small cell.

Alternatively at least one of said second and third apparatus comprises a gateway node.

In a second aspect there is provided a computer program comprising computer executable instructions which when run on one or more processors perform the method of the first aspect.

In a third aspect there is provided an apparatus comprising at least one processor; and at least one memory including computer program code; the at least one memory and the computer program code configured to, with the at least one processor, cause the apparatus at least to: store information for identifying at least one data bearer, wherein said information comprises an address and at least one further identifier for said data bearer; and wherein said data bearer is configured between said apparatus and one of a second apparatus and a third apparatus; and in response to receiving information, moving said at least one data bearer between said second apparatus and said third apparatus.

Preferably said address comprises a network address.

Preferably said further identifier comprises a general packet radio service tunnelling end-point identifier.

Preferably said at least one processor and said at least one memory are configured to cause said apparatus to store said address and said at least one further identifier in a table.

Preferably said at least one processor and said at least one memory are configured to cause said apparatus to update said table in response to said receiving information.

Preferably said at least one processor and said at least one memory are configured to cause said apparatus to match at least one data packet to said at least one data bearer by examining a header of said at least one packet.

Preferably said examining a header comprises examining one or multiple header fields of said at least one packet.

Preferably said at least one processor and said at least one memory are configured to cause said apparatus to move said bearer in response to a trigger comprising at least one of: user mobility; user data volume; user transmission frequency; user application; user priority; user quality of service class.

Preferably said first apparatus comprises a router.

Preferably said second apparatus controls one of a large cell and small cell, and said third apparatus controls the other of said large cell and said small cell.

Alternatively at least one of said second and third apparatus comprises a gateway node.

In a fourth aspect there is provided an apparatus comprising means for storing information for identifying at least one data bearer, wherein said information comprises an address and at least one further identifier for said data bearer; and wherein said data bearer is configured between said apparatus and one of a second apparatus and a third apparatus; and means for moving, in response to receiving information, said at least one data bearer between said second apparatus and said third apparatus.

Preferably said address comprises a network address.

Preferably said further identifier comprises a general packet radio service tunnelling end-point identifier.

Preferably said apparatus comprises means for storing said address and said at least one further identifier in a table.

Preferably said apparatus comprises means for updating said table in response to said receiving information.

Preferably said apparatus comprises means for matching at least one data packet to said at least one data bearer by examining a header of said at least one packet.

Preferably said examining a header comprises examining one or multiple header fields of said at least one packet.

Preferably said apparatus comprises means for moving said bearer in response to a trigger comprising at least one of: user mobility; user data volume; user transmission frequency; user application; user priority; user quality of service class.

Preferably said first apparatus comprises a router.

Preferably said second apparatus controls one of a large cell and a small cell, and said third apparatus controls the other of said large cell and said small cell.

Alternatively at least one of said second and third apparatus comprises a gateway node.

In a fifth aspect there is provided a method comprising: sending information from a first apparatus to a network node; wherein said information comprises address information and at least one further identifier associated with a data bearer configured between said network node and one of a first apparatus and a second apparatus; and said information for use by said network node to move said data bearer between said first apparatus and said second apparatus.

Preferably said address comprises a network address.

Preferably said further identifier comprises a general packet radio service tunnelling end-point identifier.

Preferably said method comprises exchanging information between said first apparatus and said second apparatus.

Preferably said information exchanged between said first apparatus and said second apparatus comprises information regarding a time to move said data bearer.

Preferably said method comprises moving said bearer in response to a trigger comprising at least one of: user mobility; user data volume; user transmission frequency; user application; user priority; user quality of service class.

Preferably said first apparatus comprises a base station controlling one of a large cell and small cell, and said second apparatus comprises a base station controlling the other of said large cell and said small cell.

Alternatively at least one of said first and second apparatus comprises a gateway node.

Preferably said network node comprises a router.

In a sixth aspect there is provided a computer program comprising computer executable instructions which when run on one or more processors perform the method of the fifth aspect.

In a seventh aspect there is provided an apparatus comprising at least one processor; and at least one memory including computer program code; the at least one memory and the computer program code configured to, with the at least one processor, cause the apparatus at least to: send information to a network node;

wherein said information comprises address information and at least one further identifier associated with a data bearer configured between said network node and one of said apparatus and a second apparatus; and said information for use by said network node to move said data bearer between said apparatus and said second apparatus.

Preferably said address comprises a network address.

Preferably said further identifier comprises a general packet radio service tunnelling end-point identifier.

Preferably said at least one processor and said at least one memory are configured to cause said apparatus to exchange information with said second apparatus.

Preferably said information exchanged between said apparatus and said second apparatus comprises information regarding a time to move said data bearer.

Preferably said at least one processor and said at least one memory are configured to cause said apparatus to move said bearer in response to a trigger comprising at least one of: user mobility; user data volume; user transmission frequency; user application; user priority; user quality of service class.

Preferably said apparatus comprises a base station controlling one of a large cell and a small cell, and said second apparatus comprises a base station controlling the other of said large cell and said small cell.

Alternatively at least one of said first and second apparatus comprises a gateway node.

Preferably said network node comprises a router.

In an eighth aspect there is provided an apparatus comprising means for sending information to a network node; wherein said information comprises address information and at least one further identifier associated with a data bearer configured between said network node and one of said apparatus and a second apparatus; and said information for use by said network node to move said data bearer between said apparatus and said second apparatus.

Preferably said address comprises a network address.

Preferably said further identifier comprises a general packet radio service tunnelling end-point identifier.

Preferably said apparatus comprises means for exchanging information with said second apparatus.

Preferably said information exchanged between said apparatus and said second apparatus comprises information regarding a time to move said data bearer.

Preferably said apparatus comprises means for moving said bearer in response to a trigger comprising at least one of: user mobility; user data volume; user transmission frequency; user application; user priority; user quality of service class.

Preferably said apparatus comprises a base station controlling one of a large cell and a small cell, and said second apparatus comprises a base station controlling the other of said large cell and said small cell.

Alternatively at least one of said apparatus and said second apparatus comprises a gateway node.

Preferably said network node comprises a router.

Some embodiments will now be described, by way of example only, with reference to the accompanying figures in which:

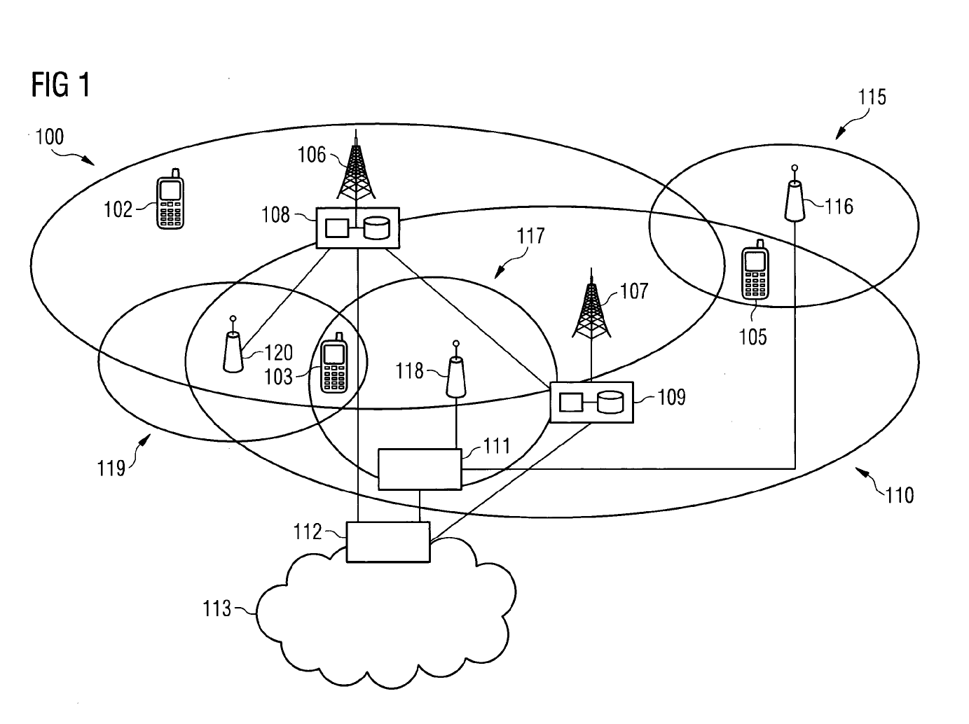

FIG. 1 shows a schematic diagram of a communication system comprising a base station and a plurality of communication devices;

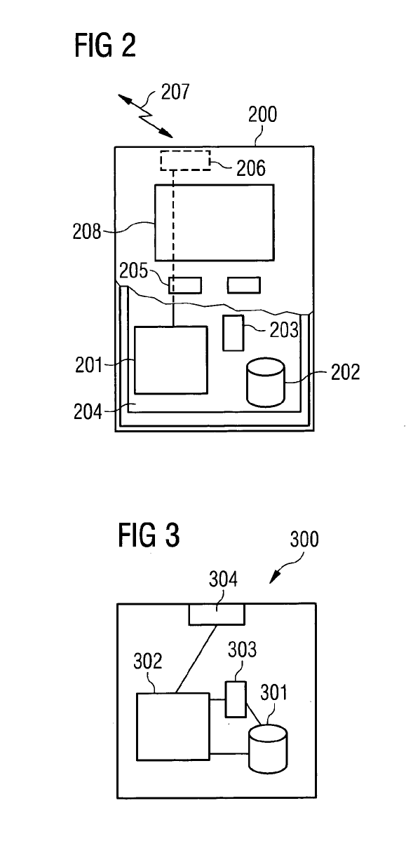

FIG. 2 shows a schematic diagram of a mobile communication device according to some embodiments;

FIG. 3 shows a schematic diagram of a control apparatus according to some embodiments;

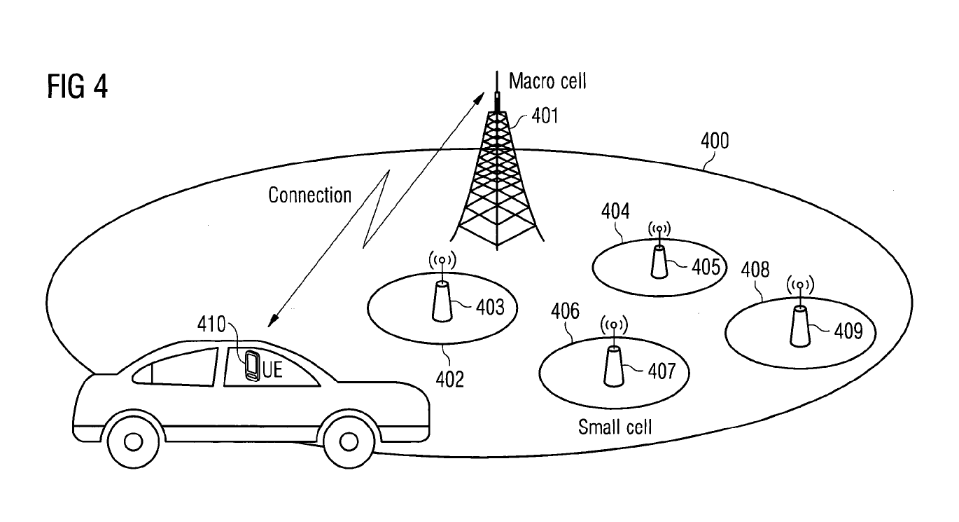

FIG. 4 schematically illustrates a high speed user equipment moving through a macro-cell;

FIG. 5 shows an example of certain elements of a communication network according to an embodiment;

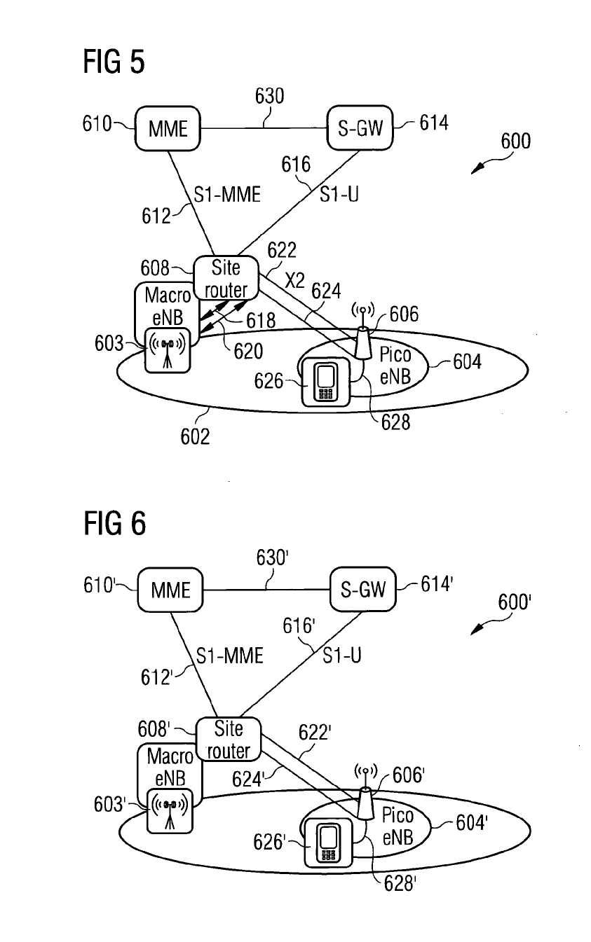

FIG. 6 shows a modified version of the embodiment of FIG. 6;

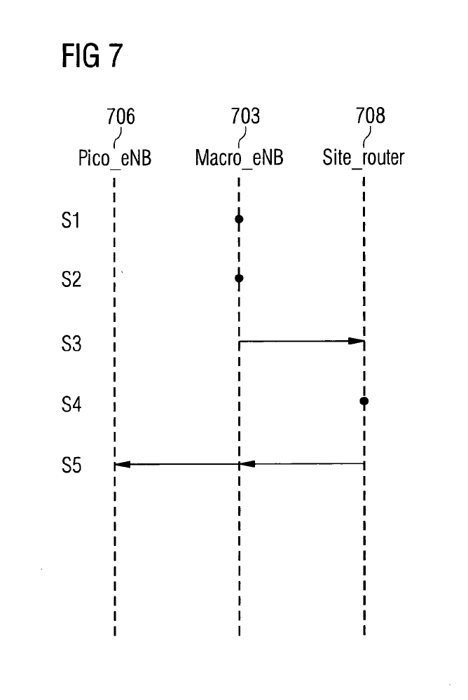

FIG. 7 shows exemplary signalling according to an embodiment.

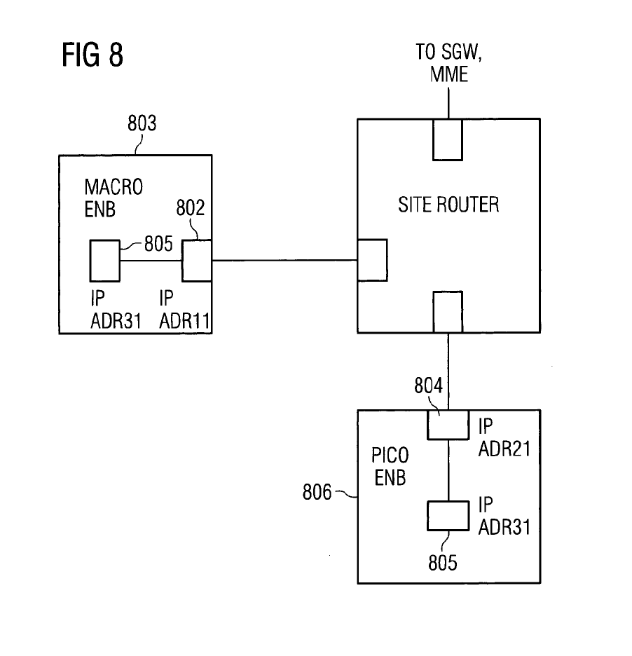

FIG. 8 shows certain network node elements according to an embodiment.

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 102, 103, 105 are provided wireless access via at least one base station or similar wireless transmitting and/or receiving node or point. In FIG. 1 an example of two overlapping access systems or radio service areas of a cellular system 100 and 110 and three smaller radio service areas 115, 117 and 119 provided by base stations 106, 107, 116, 118 and 120 are shown. Each mobile communication device and base station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell may be served by the same base station.

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is coupled to a serving gateway (S-GW) and/or mobility management entity (MME), which entities may also be pooled meaning that a plurality of these nodes may serve a plurality (set) of (e)NBs. Each UE is served by only one MME and/or S-GW at a time and the (e)NB keeps track of current association.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 102. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 102 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided, for example at base stations and mobile stations, and the transceiver apparatus 206 of FIG. 2 can provide a plurality of antenna ports. More data can be received and/or sent where there are more antenna elements. A station may comprise an array of multiple antennas. Signalling and muting patterns can be associated with TX antenna numbers or port numbers of MIMO arrangements.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a station of an access system, such as a base station. In some embodiments, base stations comprise a separate control apparatus. In other embodiments, the control apparatus can be another network element such as a radio network controller. In some embodiments, each base station may have such a control apparatus as well as a control apparatus being provided in a radio network controller. The control apparatus 109 can be arranged to provide control on communications in the service area of the system. The control apparatus 109 comprises at least one memory 301, at least one data processing unit 302, 303 and an input/output interface 304. Via the interface the control apparatus can be coupled to a receiver and a transmitter of the base station. For example the control apparatus 109 can be configured to execute an appropriate software code to provide the control functions.

The communication devices 102, 103, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP LTE specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

Some embodiments may be used with LTE HetNet where a number of small-cells are deployed with macro-cells in an overlaid way. The small-cells may share the same carrier with the macro-cell, or use different carriers.

Some embodiments are used where a relatively fast moving user equipment passes through a HetNet environment where a number of small-cells are deployed within the coverage of a macro-cell, as shown in FIG. 4.

In FIG. 4, a macro-cell 400 is served by a macro base station 401. Overlying the macro-cell 400 are, in this example, four small-cells. The first small-cell 402 is served by a base station 403. The second small-cell 404 is served by a base station 405. Likewise the third small-cell 406 is served by base station 407 and the fourth small-cell 408 is served by base station 409. As can be seen, the four small-cells are within the coverage area of the macro-cell 400. One or more of the small-cells 403, 405, 407 and 409 may be only partially in the coverage area of the macro-cell 400, and may be also in the coverage area of another macro-cell (not shown). A user equipment 410 is in a vehicle which travels through the macro-cell 400 relatively fast. It should be appreciated that the number of small-cells shown in FIG. 4 is by way of example only and in other embodiments fewer or more than four small-cells may be provided which at least partially overlap the macro-cell.

The time of stay within a small-cell may be short if a fast moving user equipment is handed over to the small-cell, and furthermore a short time of stay will incur more signalling overhead, which may result in a battery drain and/or drop in throughput.

It will be appreciated that the term “macro-cell” may also be used interchangeably with the term “large-cell” or “larger-cell”. Likewise the term “pico-cell” may be used interchangeably with the terms “micro-cell”, or “small-cell” or “smaller-cell”. Thus it will be understood that a large cell is larger than a small or pico-cell, and that a small or pico-cell is smaller than a large cell.

Each small-cell may have only a limited coverage area. As discussed with respect to FIG. 4, each small-cell may only be visible for a moving user or user equipment for a short time instant. Accordingly macro-assisted small-cells may be provided, where the macro-cell(s) provide a role in the connection between the small-cell and the user equipment. This role may comprise duties such as traffic routing and scheduling. In some embodiments the macro-cell may also act as a backup solution if the small-cell connection is lost when a radio link failure (RLF) occurs between the user equipment and the small-cell.

If the number of small-cells becomes large, the macro-cell processing capacity may experience congestion with large traffic volumes. However it may not be desirable to dimension the macro-cell HW (hardware) data routing and other processing capacity (for example a transport card in the macro base station) to cover for multiple small-cells at the beginning of the system implementation, because at the point of implementation there may be only a few small-cells present, with further cells only being added further down the line. Increasing the processing capacity of the macro-cell to account for the possibility of additional future small-cells may increase initial implementation costs. Furthermore at any one time there may only be a low number of small-cells active.

FIG. 5 shows an example of a system architecture in which a large-cell (macro-cell 602) and a small-cell (pico-cell 604) may operate. The system is shown generally at 600. The macro-cell 602 is controlled by macro-eNB 604. Pico-cell 604, which is controlled by pico-eNB 606, resides within macro-cell 602. Positioned between the macro-eNB 604 and the pico-eNB 606 is a site-router or site switch, or routing or switching apparatus, 608. The site-router 608 can arrange connectivity between eNBs and a mobility management entity (MME) 610 on an S1-MME interface 612. The site-router 608 can also support connectivity between eNBs and a serving gateway (S-GW) 614 on an S1-U interface 616.

The macro-eNB 604 can communicate with the site router 608 on interfaces 618 and 620. One or more of the interfaces 618 and 620 may be an X2 interface.

The pico-eNB 606 communicates with the site router 608 on interfaces 622 and 624. One or more of the interfaces 622 and 624 may be an X2 interface.

The pico-eNB 606 can communicate with a user equipment 626 located in pico-cell 604, via interface 628.

The data which is destined for UE 626 may always be sent to macro-eNB 604 first, before being sent to pico-eNB 606 via site router 608. This may be the case irrespective of the load on the macro-eNB 604. The MME 610 can communicate with S-GW 614 via interface 630.

FIG. 6 shows an enhancement of the FIG. 5 embodiment. Those elements which operate in the same manner as described in FIG. 5 are not described in detail again. In the embodiment of FIG. 6 the pico-eNB 606′ can communicate bi-directionally with site router 608′ on interfaces 622′ and 624′. One or both of the interfaces 622′ and 624′ may be X2 interfaces. In the embodiment of FIG. 6 one or more of downlink data destined for the pico-eNB 606′, and uplink data sent from the pico-eNB 606′, can be sent via site router 608′ without that data being sent to the macro-eNB.

The site router 608′ may in some embodiments receive a message from another entity informing the site router 608′ to direct data destined for pico-eNB 606′ directly to the pico-eNB 606′, without first sending that data to macro-eNB 603′. In some embodiments, the information comprising the instruction to the site router 608′ to send subsequent data directly to the pico-eNB 604′ may be received from the macro-eNB 603′. In other embodiments the instruction may be received from another network entity, such as the MME 610 or the S-GW 614.

In some embodiments this information is sent to the site router 608′ before the data destined for the pico-eNB 606′ is sent. Therefore when this data is received at the site router 608′, it knows to forward it directly to pico-eNB 606′, rather than forwarding it to macro-eNB 603′ first.

In some embodiments a pre-existing data-stream or bearer can be modified so that it can be sent directly from site router 608′ to pico-eNB 606′. For example a data-stream or bearer may already be in existence, for example operating in the manner as shown in FIG. 5 where it is sent to the macro-eNB 603 before being forwarded to the pico-eNB 606. Whilst this data-stream is in flow, the site router 608 may receive information instructing the site router to direct that data-stream directly to pico-eNB 606, without first sending it to macro-eNB 603. This information may be received from macro-eNB 603. Alternatively this instruction may be received from another network entity, such as MME 610 or S-GW 614. Following the receipt of this information the site router 608 will begin re-directing that data-stream directly to pico-eNB 606′, as per the embodiment of FIG. 6.

In some embodiments the information may include an instruction to the site router 608 to send a certain proportion of data from the data-stream directly to pico-eNB 606′, and to allow the remainder of the data-stream to be first sent to macro-eNB 603 prior to re-routing to pico-eNB 606′. The portion of the data stream may be defined at the granularity of the IP address that is used for the amount of bearers terminated to that IP address.

In one embodiment the decision to offload data from the macro-eNB 603 may be as a function of data volume. Additionally or alternatively, if it is determined that the data-stream is associated with a relatively static user who is likely to be camped on the pico-eNB 604 for a prolonged period, then this may also be a reason for offloading data responsibility from the macro-eNB 603. Other reasons for offloading data responsibility from the macro-eNB include user activity and transport card loading at the macro-eNB. This decision or determination may be made in the macro-eNB 603. Alternatively it may be made in any other network entity.

In embodiments where a pre-existing data-stream is moved, the entire Internet protocol traffic tunnel may be moved. The destination IP address of the Evolved Packet System (EPS) bearers may be moved so that it no longer terminates in the macro-eNB 603, but rather terminates in the pico-eNB 606. To this end the site switch 608 may comprise a routing table, forwarding table, a MAC address filtering table, or some other construct that can forward packets based on IP or MAC addresses, or on information based on IP addresses, such as Multi-protocol label switching (MPLS) labels.

As the EPS bearers are terminated to a termination point identified among other information by an IP address, some embodiments comprise a way of moving the IP address, and then informing the site switch of how the IP address can be reached in its new location so that all the bearers related to the specific IP address can be forwarded to the correct destination. The IP address may be an IPv4 or IPv6 address. In the following, example cases are presented below

The forwarding/filtering table instructs the site switch about where the destination address resides, and allows the related data-streams of certain end users to be forwarded to either the macro or pico-eNB.

FIGS. 5 and 6 show use of a site router 608 and 608′ respectively for routing information from the network to the macro-eNB 603 (or 603′) and the pico-eNB 606 (or 606′). In other embodiments a switch may be used in place of a router. The switch may be an Ethernet switch.

When a data stream is moved from a macro-eNB to a pico-eNB the macro-eNB may signal this to the pico-eNB by a radio network signalling message of the form “all users served by the IP address designated shall be moved to the pico-eNB”. For example this message could be sent directly from macro-eNB 603′ to pico-eNB 606′ on an X2 interface. Following this signalling the IP address of the macro-eNB related to those users is moved to the pico-eNB. In embodiments this means that the macro-eNB no longer responds to that IP address or receives/sends IP packets with this address, and the pico-eNB now responds to this IP address and receives/sends packets with this address. Therefore at this phase there may be signalling messages between the macro-eNB and the pico-eNB. This signalling message can be used to instruct to move user plane, control plane or both between the macro and pico cells. Depending on the site configurations the procedure may differ according to whether an IP router is used or whether an ethernet switch is used. Where an IP router is used this may be used in conjunction with routing protocol in the eNBs or with no routing protocol.

Thus it will be appreciated that the embodiments above may enable the transferring of a terminating IP address from a macro-eNB to a pico-eNB and vice versa. This has the effect of transferring all bearers which terminate with this IP address simultaneously. A refinement of this method, discussed in more detail below, enables the transfer of selected bearers which may share the same IP address. For example the transfer of only those users which have met a trigger criteria may be required. Such a trigger criteria may be a user with a high data volume, a fast-moving user undergoing rapid cell changes, or any other criteria.

Accordingly, embodiments where the traffic termination points may be moved at the site router on a user basis are discussed below.

In LTE, user bearers at the S1 interface are typically terminated using a termination point identified by IP address, user datagram protocol (UDP) port, and user general packet radio service tunnelling endpoint identifier (GTPU-TEID). The IP address is typically the same for a number of bearers and the UDP destination port is fixed at 2152, so it is proposed to use the GTPU-TEID to identify individual user bearers.

That is when it is required to switch user bearers individually by a site router the information encoded to the GTPU-TEID field is proposed to be used in addition to the IP address by the site router when forwarding packets from the core network towards the eNB.

To this end it is proposed to implement a forwarding table in the site router which incorporates GTPU-TEIDs in addition to IP addresses. The forwarding table and GTPU-TEID entries can be updated by information communicated by the eNBs to the router.

In embodiments there is proposed a GTPU-TEID aware site router. This is discussed further below, using the network architecture of FIG. 6 as an example.

The forwarding table may instruct the GTPU-TEID aware site router to forward the IP packets towards the intended destination. The intended destination could be:

A) Directly reachable

B) Reachable via another router (next hop address/interface)

Both of these cases are described below as non-limiting examples of possible applications, with the basic principle staying the same, but with differences in the detailed forwarding table entries of the site router.

Case A) applies e. g. when the network interface of the eNBs is configured with the IP destination address in question, and the site router and the eNB are on the same Ethernet link (subnet).

Case B) applies e. g. when the destination IP address is configured as application (virtual) address within the eNB, and this destination is reachable via the network interface of the eNB. In this case, the site router uses the IP address configured on the network interface as the next hop address.

Case B) applies also in general in cases where the destination is reachable via other routers.

With Cases A) and B) typical macro-pico network configurations and IP address configurations of the eNB are covered.

The GTPU-TEID aware site router, in addition to IP destination addresses (and potentially other fields of the IP packet header and possibly UDP/TCP packet header fields) utilizes the GTPU-TEID field in its forwarding decisions, in addition to IP destination addresses. The GTPU TEID field (located at the GTPU header), identifies a single bearer. The IP destination address and the GTPU TEID value are used in combination to search for a match in the forwarding table. If a match is found for the specific combination (IP address+GTPU TE ID), the packet is forwarded according to the entry in the forwarding table. If there is no match for the combination (IP address+GTPU TE ID), then the forwarding table is searched for a match with the IP address, ignoring the GTPU TEID. If a match is found for the destination network without the GTPU TEID (as a less specific entry), then the packet is forwarded according to that specific entry of the forwarding table.

The above mechanism allows the site router to
1) direct any individual bearer to either macro or pico, based on specific IP destination address and GTPU TEID
2) Direct all other bearers and traffic to either macro or pico, based on finding a match for the IP address alone, with no match for GTPU TEID

This allows the site router to treat the GTPU TEID field as an extension (or additional information) of the IP destination address. The routing decision in the site router can additionally use further fields of the IP packet header, or UDP/TCP, or other protocol headers, e.g. in the form of policy based routing.

As an example, for case B) reference is made to FIG. 8. In FIG. 8, IP address “IP ADR 11” is configured to the network interface 802 of the macro-eNB 803, and IP address “IP ADR 21” is configured to the network interface 804 of the pico-eNB 806. The user plane bearer termination point 805 uses an IP address “IP ADR 31” configured as an application (virtual) address of the macro-eNB 803, and pico-eNB 806. There may be additional IP addresses configured for other purposes on both macro and pico eNB, either to the network interfaces or as application (virtual) addresses.

Thus in the downlink direction, user plane bearers terminate to “IP ADR 31”, which may for any bearer reside on either the macro-eNB 803 or the pico-eNB 806. In the uplink direction, packets are sent to the bearer termination point (IP address) residing in the core network.

An example forwarding table of a site router (for the downlink direction) is given in Table 1 below.

TABLE 1

| | | Next hop/Outgoing |
|---|---|---|
| Destination | GTPU TEID | I/F |
| IP ADR 31 | VALUE1 | IP ADR 11 |
| IP ADR 31 | VALUE2 | IP ADR 21 |
| IP ADR 31 | any other value | IP ADR 21 |

The destination may be given as an individual address or as a (sub) network, e. g. as prefix/length.

The first entry in Table 1 instructs the site router to forward packets with IP destination address matching “IP ADR 31” and GTPU-TEID matching “VALUE 1” to the next hop address of “IP ADR 11”. The second entry instructs the site router to forward packets with IP destination address matching “IP ADR 31” and GTPU-TEID matching “VALUE 2” to the next hop address of “IP ADR 21”. The third entry instructs the site router to forward packets with IP destination address matching “IP ADR 31” and GTPU TEID not matching “VALUE 1” or “VALUE 2” to the next hop address of “IP ADR 21”.

The IP addresses may be e. g. IPv4 or IPv6 addresses. The destinations in the forwarding table as mentioned may be routes to individual hosts or routes to other networks. GTPU-TEID values may be any values complying with 3GPP valid value ranges.

When a bearer is moved between macro and pico eNB, the site router is informed by either macro and/or pico eNB, so that the site router can install a new entry, or modify an existing entry in the forwarding table for the downlink direction. In the uplink direction, the site router needs to have entries for reaching the termination points of the peer entity (e.g. SGW). When a bearer is moved, the macro and pico-eNBs need to inform each other of the correct termination point address in the core network (SGW) so that packets can be sent to the correct IP destination address residing in the core network.

The example entries define how individual bearers can be directed for the downlink direction either to macro or pico-eNB. In the uplink direction, the macro and pico-eNBs need to know the destination IP addess for the bearer termination point in the core network, and the site router needs to know how to reach this destination. Information is thus shared between macro and pico-eNB when the bearer is moved.

In the uplink direction, the site router may not need to update its forwarding table when the bearer is moved, if the destination address stays the same. In this case, the packet in the uplink direction may be originated from a different endpoint (macro or pico-eNB) when the bearer is moved, but from the site router towards the core network the bearers may be directed via the same route. It may be that in the uplink direction GTPU-TEID values are ignored, in which case forwarding decisions are done without any reference to the GTPU-TEID values.

For example the site router 608′ of FIG. 6 would be provided with GTPU-TEID awareness functionality. Using this information the site router can move specific data bearers (i.e. data bearers for individual users) from the macro-eNB 603′ to the pico-eNB 606′, and vice versa.

The site router 608′ can forward traffic by examining the IP packet header and the destination address and the GTPU-TEID value and then search in the forwarding table for a matching entry. When a matching entry is found the outgoing interface/next hop can be determined, and the packet can be forwarded accordingly towards the destination, which in this case is one or other of macro-eNB 603′ and pico-eNB 604′. Accordingly packets are sent to different next-hops dependent upon the GTPU-TEID.

It will be appreciated that three entries have been shown in Table 1 for the purposes of explanation only, and that in other embodiments any number of entries may be contained in such a table. Each entry may then correspond to a single bearer (as in the case with entry 1 and entry 2 in the example), or multiple bearers (as is the case with the third entry in the example)

As the method works on individual bearers, granularity is defined by the destination IP address and GTPU-TEID, it allows any single bearer to be directed either to macro or pico-eNB. The bearers may belong to the same user or to different users. So a specific bearer of a user may be directed via pico-eNB, while another bearer of the same user may be directed via macro-eNB. This arrangement allows separating a voice bearer from a data bearer, for example.

As shown in the last row of the Table 1 example above, the method allows directing all other bearers to macro or pico-eNB, without generating a separate entry for each of these bearers to the forwarding table. This reduces the size of the forwarding table, and simplifies the operation. Also, control plane or management plane traffic may be directed via destination address alone, without any GTPU-TEID definition.

In some embodiments support is provided by a site route vendor to assist with routing based on GTPU headers. This may be utilised where the site router in question does not support routing based on 3GPP specific GTPU headers. The site route vendor may use route maps or similar for packet matching. The packet matching, including GTPU-TEID, may be done with hardware based implementation (such as microcode) to avoid performance penalties related to software based route maps. In some embodiments application specific microcode may be created on top of the router operating system.

Embodiments also provide a method or protocol for enabling entries to be made to the forwarding table in the site router 608′. That is the forwarding table may be updated. The updating of the forwarding table may be made in response to communication between the site router 608′ and the macro-eNB 603′ or pico-eNB 606′. Therefore the GTPU-TEID needs to be communicated between the macro-eNB and the site router, and between the pico-eNB and the site router, and the site router needs to know how to reach the destinations that are residing on macro and pico-eNB. The IP layer reachability may be provided, for example, manually with static entries, or dynamically by routing protocols. The additional GTPU-TEID information may be provided as additional information, with a specific protocol or communication method between the macro and pico-eNBs and the site router. The same communication method may also provide the IP layer information, so that all of the information needed by the site router is given by the same communication method or protocol.

In one embodiment this is done using a network management interface such that the eNBs can send configuration commands, configurations files, or script files to the router. This embodiment is relatively easy to implement.

In another embodiment a software defined networking based option such as OpenFlow is used. Such an option is intended for a controller controlling the switch, as a control plane element, which would e.g. be the eNBs. It is also intended for a switch device which would be a user plane element such as the router supporting the traffic flow.

In a further embodiment the communication method comprises proprietary or modified protocols between the eNBs and the site switch or router. Such an embodiment may optimise use with a site-router vendor since existing protocols can be used.

Embodiments may provide additional signalling messages over the radio network control plane (X2C) that can instruct a single user bearer to be moved, as defined by the GTPU-TEID and IP address. This additional signalling message or new information element can provide information regarding the switch or move of the traffic termination point between macro and pico-eNB indicating a “RAN internal” transfer. In embodiments the additional information elements comprises the GTPU-TEID so that the site router can use the forwarding table to identify an individual bearer instead of an IP address where multiple bearers typically terminates. The signalling messages may also convey the information of the correct termination point in the core network, between the macro and pico eNBs, for the uplink direction.

Example signalling messages may include:
Instruction to “Move bearer”, defined by DL and UL IP addresses and GTPU TEIDs to macro or pico-eNB.

The signalling message could be based on 3GPP defined X2 protocol, operated between the site router and the macro eNB, site router and the pico-eNB, and macro eNB and pico-eNB.

The site router may install a new entry to its forwarding table, based on the signalling message received. The site router may also withdraw an existing entry, if a newer (more recent) signalling message is received with information concerning the same bearer (identified by the IP destination address and the GTPU TEID).

Some embodiments also provide resource management that utilises bearer specific triggers for transferring individual bearers. “Bearer specific trigger” refers to resources that could be optimised on a bearer basis, instead of on an IP address basis. Since in embodiments the radio resources are managed on a bearer basis then the “triggers” may also exist on the bearer basis, thus allowing finer granularity resource management.

The switching of the bearer in question (e.g. identified by IP address plus GTPU-TEID) between macro and pico BTS can be based, for example, on the following triggers: loading of macro BTS transmission units or number of users; user mobility e.g. high mobility users preferably maintained in macro-BTS; user data volume, high data volume preferably switched to pico-BTS; user transmission frequency, high frequency transmissions preferably switched to pico-BTS; user application, BTS can identify the application and switch IP address accordingly; user priority or quality of service class.

In embodiments the macro and pico-base stations can directly exchange information to decide when the bearer should be moved. As discussed above this signalling can take place on the X2 interface. For example the signalling can indicate that the macro or pico base station would like to transfer or receive the IP address for one of the users. This signalling may also indicate some of the above-mentioned triggers.

FIG. 7 shows exemplary signalling between a pico-eNB 706, a macro-eNB 703, and a site-router 708. In this example the site router 708 is configured with a forwarding table as discussed with relation to Table 1 above i.e. containing the IP addresses and GTPU-TEID of a number of data bearers.

At step S1 both macro-eNB 703 and pico-eNB 706 are operating normally e.g. servicing a number of users within their cells. At step S2 it is determined at macro-eNB 703 that it is at or near its cell-load capacity and thus would like to offload one or more data bearers to pico-eNB 706. It will be appreciated that this is by way of example only and that any of the other “triggers” discussed above could be determined at step S2.

Accordingly at step S3 macro-eNB 703 sends a message to site router 708. This message identifies the one or more data bearers that it wishes to offload to pico-eNB 706. As discussed above the data bearers are identified by their IP address and their GTPU-TEID.

At step S4 the site router 708 updates its forwarding table to reflect that data related to those identified data bearers is now to be sent via pico-eNB 706 rather than macro-eNB 703. Accordingly any traffic arriving at site router 708 matching the identified IP address and GTPU-TEID will be forwarded to pico-eNB 706. At step S5 the site router 708 may inform the macro-eNB 703 and the pico-eNB 706 of the update, so that the eNBs are kept updated with the cell conditions.

It will of course be appreciated that FIG. 7 is for the purpose of explanation only and that the “trigger” may occur at the pico-eNB rather than the macro-eNB, ultimately resulting in offload of a data bearer from the pico-eNB to the macro-eNB.

It will be appreciated that the above described embodiments enable the movement of data bearers associated with those users for whom the defined trigger criteria is met e.g. for a user with high data volume, or for a user with rapid cell changes or other criteria.

The GTPU-TEID based forwarding could be implemented without major changes to network procedures since the procedures of packet header examination and forwarding table searches are already supported.

It will be appreciated that the base stations or pico and macro-eNBs according to the embodiments may comprise the features of a control apparatus as described with respect to FIG. 3. For example in embodiments the eNBs may comprise memory means in the form of a memory 301, processing means in the form of processing units 302 and 303, and radio or transceiver means connected to input/output interface 304.

It will be appreciated that the embodiments are not limited to macro and pico-eNBs. There may also be other scenarios, for example where individual bearers are similarly moved in the core network. Cloud type applications may have a similar site router and multiple gateways such as a signalling gateway (SGW), or multiple SGW processing units which share the load. That is the concept is similar but instead of macro and pico eNBs there would be multiple SGWs. A trigger to move the bearer in the core network side could be, for example, a load situation of the core network nodes.

In further embodiments it is also possible to have a combination of a site router and eNBs (pico and macro) on the access side, and then (possibly different) GTPU aware site routers and signalling gateways on the core side.

Embodiments of the invention may apply to the uplink and downlink direction. The routing tables may be different for the uplink and downlink direction. The triggers for changing the uplink and downlink routing tables can be different, or can also be the same.

It is noted that whilst embodiments have been described in relation to LTE, similar principles may be applied to any other communication system or to further developments with LTE. Therefore, although certain embodiments are described above by way of example with reference to certain exemplifying architectures for wireless networks, technologies and standards, embodiments may be applied to any other suitable forms of communication systems than those illustrated and described herein.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more of any of the other embodiments previously discussed.

1. A method comprising:
storing, at a first apparatus, information for identifying at least one data bearer, wherein said information comprises an address and at least one further identifier for said data bearer; and wherein said data bearer is configured between said first apparatus and one of a second apparatus and a third apparatus; and
in response to receiving information, moving said at least one data bearer between said second apparatus and said third apparatus.

2. A method as set forth in claim 1, wherein said address comprises a network address.

3. A method as set forth in claim 1, wherein said further identifier comprises a general packet radio service tunnelling end-point identifier.

4. A method as set forth in claim 1, wherein said method comprises matching at least one data packet to said at least one data bearer by examining a header of said at least one packet, and wherein said examining a header comprises examining one or multiple header fields of said at least one packet, and wherein said method comprises moving said bearer in response to a trigger comprising at least one of: user mobility; user data volume; user transmission frequency; user application; user priority; user quality of service class.

5. A method as set forth in claim 1, wherein said first apparatus comprises a router, and wherein said second apparatus controls one of a large cell and a small cell, and said third apparatus controls the other of said large cell and said small cell.

6. A computer program comprising computer executable instructions which when run on one or more processors perform the method of claim 1.

7. An apparatus comprising
at least one processor;
and at least one memory including computer program code;
the at least one memory and the computer program code configured to, with the at least one processor, cause the apparatus at least to:
store information for identifying at least one data bearer, wherein said information comprises an address and at least one further identifier for said data bearer; and wherein said data bearer is configured between said apparatus and one of a second apparatus and a third apparatus; and
in response to receiving information, moving said at least one data bearer between said second apparatus and said third apparatus.

8. An apparatus as set forth in claim 7, wherein said address comprises a network address.

9. An apparatus as set forth in claim 7 or claim 8, wherein said further identifier comprises a general packet radio service tunnelling end-point identifier.

10. An apparatus as set forth in claim 7, wherein said at least one processor and said at least one memory are configured to cause the apparatus to match at least one data packet to said at least one data bearer by examining a header of said at least one packet, wherein said examining a header comprises examining one or multiple header fields of said at least one packet, and wherein said at least one processor and said at least one memory are configured to cause the apparatus to move said bearer in response to a trigger comprising at least one of: user mobility; user data volume; user transmission frequency; user application; user priority; user quality of service class.

11. An apparatus as set forth in claim 7, wherein said apparatus comprises a router, said second apparatus controls one of a large cell and a small cell, and said third apparatus controls the other of said large cell and said small cell.

12. A method comprising:
sending information from a first apparatus to a network node;
wherein said information comprises address information and at least one further identifier associated with a data bearer configured between said network node and one of said first apparatus and a second apparatus; and
said information for use by said network node to move said data bearer between said first apparatus and said second apparatus.

13. A method as set forth in claim 12, wherein said address comprises a network address, and wherein said further identifier comprises a general packet radio service tunnelling end-point identifier.

14. A method as set forth in claim 12, wherein said method comprises exchanging information between said first apparatus and said second apparatus, and wherein said information exchanged between said first apparatus and said second apparatus comprises information regarding a time to move said data bearer, and wherein said method comprises moving said bearer in response to a trigger comprising at least one of: user mobility; user data volume; user transmission frequency; user application; user priority; user quality of service class.

15. A method as set forth in claim 12, wherein said first apparatus comprises a base station controlling one of a large cell and a small cell, and said second apparatus comprises a base station controlling the other of said large cell and said small cell, and wherein said network node comprises a router.

16. A computer program comprising computer executable instructions which when run on one or more processors perform the method of claim 12.

17. An apparatus comprising
at least one processor;
and at least one memory including computer program code;
the at least one memory and the computer program code configured to, with the at least one processor, cause the apparatus at least to:
send information to a network node;
wherein said information comprises address information and at least one further identifier associated with a data bearer configured between said network node and one of said apparatus and a second apparatus; and
said information for use by said network node to move said data bearer between said apparatus and said second apparatus.

18. An apparatus as set forth in claim 17, wherein said address comprises a network address, and wherein said further identifier comprises a general packet radio service tunnelling end-point identifier.

19. An apparatus as set forth in claim 17, wherein said at least one processor and said at least one memory are configured to cause said apparatus to exchange information with said second apparatus, wherein said information exchanged between said apparatus and said second apparatus comprises information regarding a time to move said data bearer, and wherein said at least one processor and said at least one memory are configured to cause said apparatus to move said bearer in response to a trigger comprising at least one of: user mobility; user data volume; user transmission frequency; user application; user priority; user quality of service class.

20. An apparatus as set forth in claim 17, wherein said apparatus comprises a base station controlling one of a large cell and a small cell, and said second apparatus comprises a base station controlling the other of said large cell and said small cell, and wherein said network node comprises a router.
